(19) United States
(12) Patent Application Publication
(10) Pub. No.: US 2015/0195342 A1
(43) Pub. Date: Jul. 9, 2015

(54) REMOTE CONFIGURATION OF DATA PROCESSING DEVICES IN A CLUSTER COMPUTING SYSTEM

(71) Applicant: NVIDIA Corporation, Santa Clara, CA (US)

(72) Inventors: Abdeali Panvelwala, Pune (IN); Sasaank Botlaguduru, Pune (IN)

(73) Assignee: NVIDIA Corporation, Santa Clara, CA (US)

(21) Appl. No.: 14/146,726

(22) Filed: Jan. 3, 2014

(51) Int. Cl. H04L 29/08; H04L 29/06

(52) U.S. Cl. CPC H04L 67/10; H04L 67/42

(57) ABSTRACT

A method includes implementing a cluster computing system including a number of data processing devices coupled to one another in a daisy-chain configuration and communicatively coupled to a server, executing a process on the server and executing an instance of the process on each data processing device. The method also includes remotely configuring, through the server, one or more specific parameter(s) of a display unit associated with a first data processing device, a screen of the display unit, a processor thereof, a memory communicatively coupled to the processor, an algorithm executing thereon and/or a power supply of the first data processing device based on the execution of the process. Further, the method includes remotely configuring, through the server, a same one or more specific parameter(s) associated with a sequentially next data processing device of the cluster computing system based on the remote configuration associated with the first data processing device.

### FIELD OF TECHNOLOGY

This disclosure relates generally to cluster computing systems and, more particularly, to a method, a device and/or a system of remote configuration of data processing devices in a cluster computing system.

### BACKGROUND

A cluster computing system may include a number of data processing devices (e.g., laptop computers, desktop computers, servers, smart displays). An administrator of the cluster computing system may be required to configure hardware (e.g., display) topologies of one or more data processing device(s) of the cluster computing system. For the aforementioned purpose, the administrator may have to individually modify hardware topologies on the one or more data processing device(s). The aforementioned process is time-consuming and frustrating to the administrator. Further, the configuration may not be possible if the administrator is at a location remote from that of the number of data processing devices.

### SUMMARY

Disclosed are a method, a device and/or a system of remote configuration of data processing devices in a cluster computing system.

In one aspect, a method includes implementing a cluster computing system including a number of data processing devices communicatively coupled to a server through a computer network. The number of data processing devices includes data processing devices coupled to one another in a daisy-chain configuration, and each data processing device of the number of data processing devices is at a location remote from that of the server. The method also includes executing a process on the server, executing an instance of the process on the each data processing device of the number of data processing devices, and remotely configuring, through the server, one or more specific parameter(s) of a display unit associated with a first data processing device of the number of data processing devices, a screen of the display unit, a processor of the first data processing device, a memory of the first data processing device communicatively coupled to the processor, an algorithm executing on the processor and/or a power supply of the first data processing device based on the execution of the process on the server.

Further, the method includes remotely configuring, through the server, a same one or more specific parameter(s) associated with a sequentially next data processing device of the cluster computing system based on the remote configuration of the one or more specific parameter(s) associated with the first data processing device and the continued execution of the process on the server.

In another aspect, a non-transitory medium, readable through a server and a number of data processing devices communicatively coupled to the server through a computer network to form a cluster computing system and including instructions embodied therein that are executable through the server and the number of data processing devices, is disclosed. The number of data processing devices includes data processing devices coupled to one another in a daisy-chain configuration, and each data processing device of the number of data processing devices is at a location remote from that of the server. The non-transitory medium includes instructions to execute a process on the server, and instructions to execute an instance of the process on the each data processing device of the number of data processing devices.

The non-transitory medium also includes instructions to remotely configure, through the server, one or more specific parameter(s) of a display unit associated with a first data processing device of the number of data processing devices, a screen of the display unit, a processor of the first data processing device, a memory of the first data processing device communicatively coupled to the processor, an algorithm executing on the processor and/or a power supply of the first data processing device based on the execution of the process on the server. Further, the non-transitory medium includes instructions to remotely configure, through the server, a same one or more specific parameter(s) associated with a sequentially next data processing device of the cluster computing system based on the remote configuration of the one or more specific parameter(s) associated with the first data processing device and the continued execution of the process on the server.

In yet another aspect, a cluster computing system is disclosed. The cluster computing system includes a server configured to execute a process thereon, and a number of data processing devices communicatively coupled to the server through a computer network. The number of data processing devices includes data processing devices coupled to one another in a daisy-chain configuration. Each data processing device of the number of data processing devices is at a location remote from that of the server. The each data processing device is configured to execute an instance of the process thereon. The server is configured to remotely configure one or more specific parameter(s) of a display unit associated with a first data processing device of the number of data processing devices, a screen of the display unit, a processor of the first data processing device, a memory of the first data processing device communicatively coupled to the processor, an algorithm executing on the processor and/or a power supply of the first data processing device based on the execution of the process.

The server is also configured to remotely configure a same one or more specific parameter(s) associated with a sequentially next data processing device of the cluster computing system based on the remote configuration of the one or more specific parameter(s) associated with the first data processing device and the continued execution of the process.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a cluster computing system, according to one or more embodiments.

FIG. 2 is an illustrative view of a user interface provided by an application executing on a server associated with the cluster computing system of FIG. 1.

FIG. 3 is an illustrative view of remote configuration of topologies of display units of the cluster computing system of FIG. 1 through the server, according to one or more embodiments.

FIG. 4 is an illustrative view of data flow between a first data processing device of the cluster computing system of FIG. 1 and the server during the remote configuration of settings associated therewith, according to one or more embodiments.

FIG. 5 is a process flow diagram detailing the operations involved in remote configuration of the data processing devices of the cluster computing system of FIG. 1, according to one or more embodiments

Other features of the present embodiments will be apparent from the accompanying drawings and from the detailed description that follows.

### DETAILED DESCRIPTION

Example embodiments, as described below, may be used to provide a method, a device and/or a system of remote configuration of data processing devices in a cluster computing system. Although the present embodiments have been described with reference to specific example embodiments, it will be evident that various modifications and changes may be made to these embodiments without departing from the broader spirit and scope of the various embodiments.

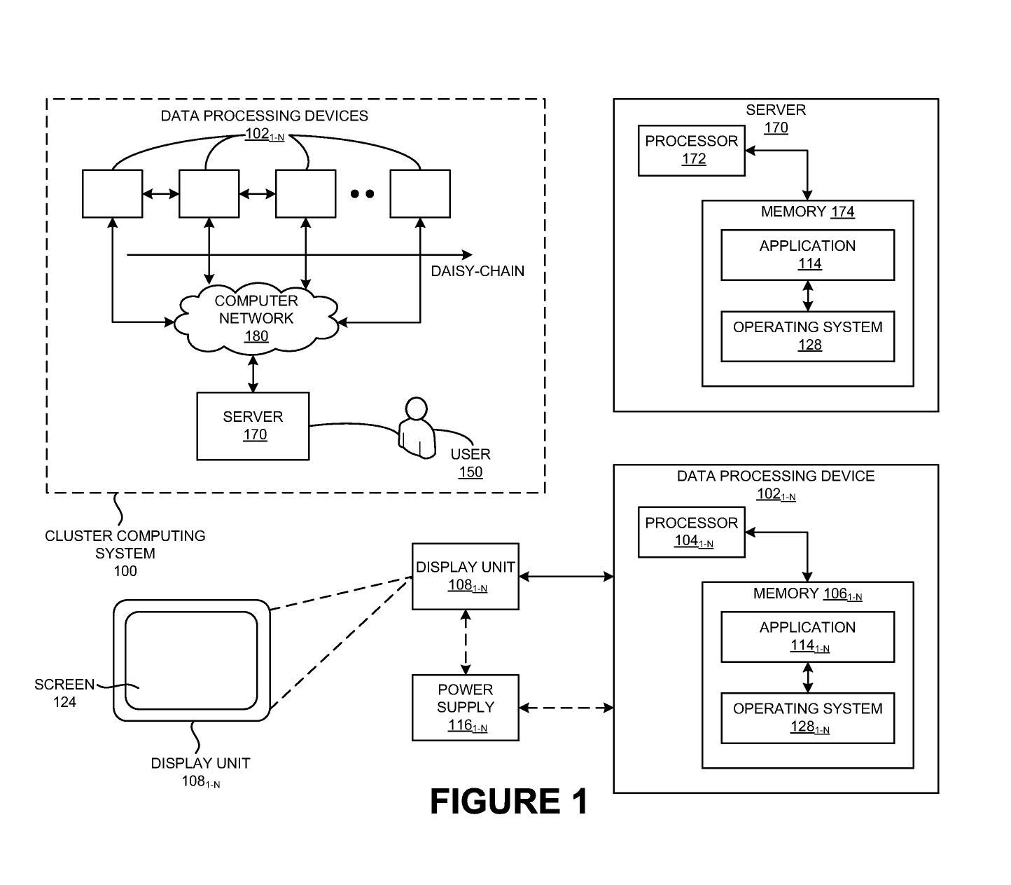

FIG. 1 shows a cluster computing system 100, according to one or more embodiments. In one or more embodiment, cluster computing system 100 may include a number of data processing devices 102_{1-N} serving as nodes thereof. Each data processing device 102_{1-N} may be a desktop computer, a laptop computer, a notebook computer, a netbook, a mobile device such as a mobile phone and a tablet or a smart display. Other forms of the each data processing device 102_{1-N} are within the scope of the exemplary embodiments discussed herein. In one or more embodiments, the each data processing device 102_{1-N} may include a processor 104_{1-N} (e.g., a Central Processing Unit (CPU), a Graphics Processing Unit (GPU) and/or another form of a processor) communicatively coupled to a memory 106_{1-N} (e.g., a volatile memory and/or a non-volatile memory); memory 106_{1-N} may include storage locations addressable through processor 104_{1-N}.

In one or more embodiments, the each data processing device 102_{1-N} may include (or, be associated with) a display unit 108_{1-N} (e.g., a Cathode Ray Tube (CRT) display, a Liquid Crystal Display (LCD)) configured to have display data output from processor 104_{1-N} rendered thereon. In one or more embodiments, the each data processing device 102_{1-N} may be communicatively coupled to a server 170 (e.g., through a computer network 180 such as a Wide Area Network (WAN), a Local Area Network (LAN) and/or a wireless network). In one or more embodiments, server 170 may be at a location remote from a location of the each data processing device 102_{1-N}; FIG. 1 also shows server 170 being associated with a user 150 (e.g., an administrator of computer network 180/cluster computing system 100). In one or more embodiments, data processing devices 102_{1-N} may be communicatively coupled to one another (e.g., through an Ethernet cable) in a daisy-chain, as shown in FIG. 1; here, the each data processing device 102_{1-N} may be communicatively coupled to an adjacent data processing device 102_{1-N} through wired and/or wireless means.

In one or more embodiments, server 170 may execute a process (e.g., application 114 shown as being stored in a memory 174 of server 170; memory 174 is shown as being communicatively coupled to a processor 172 (e.g., again a CPU, a GPU and/or another processor) thereof) thereon to enable configuration of a screen 124 of display unit 108_{1-N} associated with the each data processing device 102_{1-N} and/or display unit 108_{1-N}. An example application 114 may be NVIDIA®'s Control Panel configured to control GPUs and Mobile Communication Processors (MCPs). Further, in one or more embodiments, the each data processing device 102_{1-N} may also be configured to execute an instance (e.g., application 114_{1-N}) of the process executing on server 170 thereon. FIG. 1 also shows application 114_{1-N} as being stored in memory 106_{1-N}.

In one or more embodiments, the each data processing device 102_{1-N} may be configured to derive power from a power supply 116_{1-N} (e.g., a battery). FIG. 1 further shows power supply 116_{1-N} of the each data processing device 102_{1-N}; although power supply 116_{1-N} is shown as being external to the each data processing device 102_{1-N}, it should be noted that power supply 116_{1-N} may be considered as part of the each data processing device 102_{1-N}. In one or more embodiments, the each data processing device 102_{1-N} may execute an operating system 128_{1-N} thereon; FIG. 1 shows operating system 128_{1-N} as being stored in memory 106_{1-N}. In one or more embodiments, memory 106_{1-N} may include library files (not shown) stored therein in order to convenience compatibility of data transmission/reception associated with the each data processing device 102_{1-N} with a number of operating system environments.

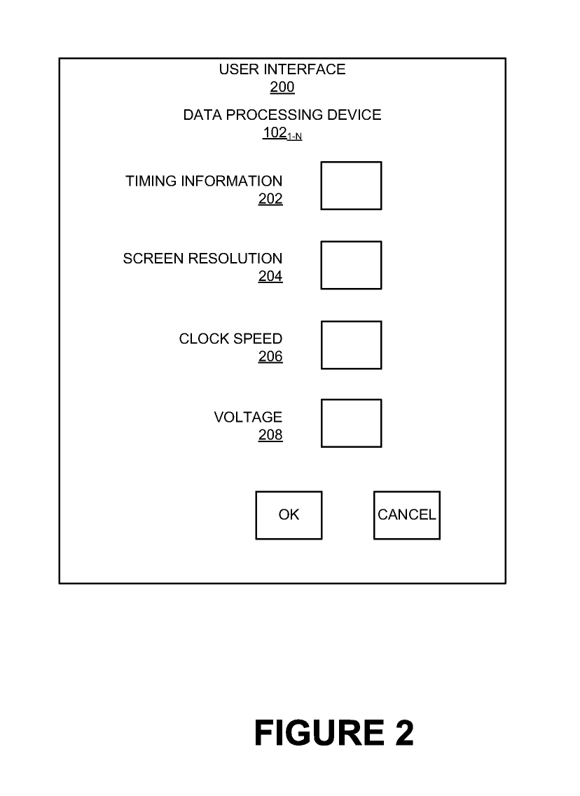

In one or more embodiments, application 114 may provide an interface to user 150 of server 170 to control settings with respect to screen 124, display unit 108_{1-N}, processor 104_{1-N}, memory 106_{1-N} and/or power supply 116_{1-N}. As mentioned above, server 170 may be at a location remote from that of data processing devices 102_{1-N}. Thus, exemplary embodiments may provide for remote configuration of settings associated with data processing devices 102_{1-N} of cluster computing system 100. FIG. 2 shows an example user interface 200 provided through application 114 at server 170. It should be noted that said user interface 200 may be provided also through an operating system 128 executing on server 170. User 150 may be able to modify settings associated with screen 124, display unit 108_{1-N}, processor 104_{1-N}, memory 106_{1-N} and/or power supply 116_{1-N} through user interface 200. Other variations and/or modifications are within the scope of the exemplary embodiments discussed herein.

FIG. 2 shows example parameters capable of being configured by user 150; the example parameters may include timing information 202 for display unit 108_{1-N}, screen resolution 204 associated with display unit 108_{1-N}, clock speed 206 associated with processor 104_{1-N} and voltage 208 associated with power supply 116_{1-N} and/or processor 104_{1-N}. Other parameters are within the scope of the exemplary embodiments discussed herein. For example, each of two or more processor(s) 104_{1-N} within cluster computing system 100 may execute a same noise reduction algorithm on display data to be rendered on the corresponding two or more display unit(s) 108_{1-N}; a set of parameters of the noise reduction algorithm may provide for optimal performance with respect to the display data rendered on a particular display unit 108_{1-N}; user interface 200 may provide a capability to remotely apply the same set of parameters to the noise reduction algorithm when executing on one or more other processor(s) 104_{1-N} associated with one or more other display unit(s) 108_{1-N}.

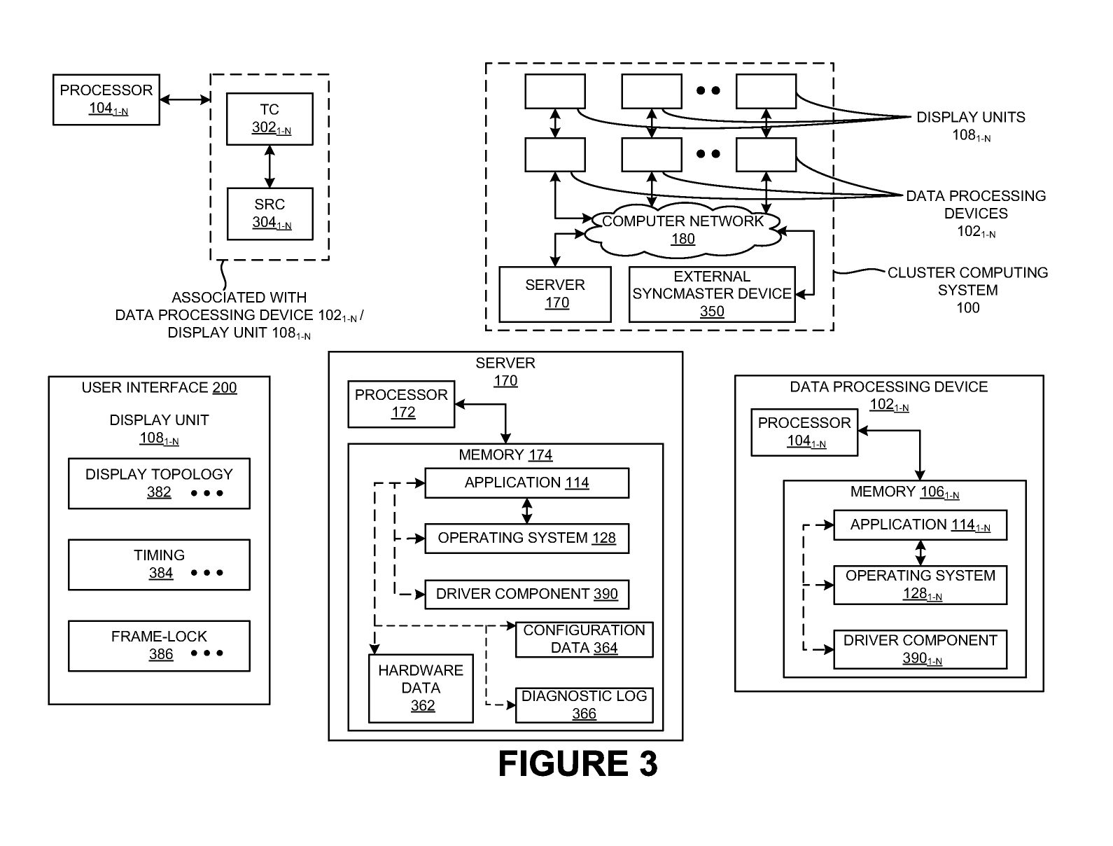

FIG. 3 shows remote configuration of topologies of display units 108_{1-N} of cluster computing system 100 through server 170, according to one or more embodiments. FIG. 3 shows each processor 104_{1-N} as being associated with a timing controller (TC) 302_{1-N} and a self-refresh controller (SRC) 304_{1-N}. It should be noted that a data processing device 102_{1-N} may also be a smart display device, in which case TC 302_{1-N} and/or SRC 304_{1-N} may be part of display unit 108_{1-N} associated therewith. TC 302_{1-N} and SRC 304_{1-N} may be implemented in software, hardware or a combination thereof. In one or more embodiments, TC 302_{1-N} may generate timing signals for display unit 108_{1-N} and SRC 304_{1-N} may be configured to generate video signals to be rendered on display unit 108_{1-N} based on display data stored in memory 106_{1-N}. SRC 304_{1-N} may, particularly, be utilized in a self-refresh mode of operation of display unit 108_{1-N}. Timing controllers and self-refresh controllers are well known to one skilled in the art; detailed discussion associated therewith has, therefore, been skipped for the sake of brevity.

In a typical implementation, user 150 may create a display topology on each data processing device 102_{1-N}, set a common timing for all display units 108_{1-N} associated with data processing devices 102_{1-N} and create a SyncMaster device out of data processing devices 102_{1-N} or a data processing device external to data processing devices 102_{1-N}. User 150 may then frame-lock all display units 108_{1-N} to the SyncMaster device. Frame locking may involve transmitting a frame lock signal to synchronize video frames rendered on each display unit 108_{1-N} and to redraw multiple display units 108_{1-N} at the same time. When data associated with an application (e.g., application 114, another application) is displayed across multiple display units 108_{1-N}, frame-locking may enable maintaining image/video frame continuity therein. Said image/video frame continuity enables creation of a virtual display canvas across the multiple display units 108_{1-N}.

It should be noted that “SyncMaster” has been utilized to denote a data processing device employed as a reference with respect to frame-locking data processing devices 102_{1-N}. Other terms such as “synchronization reference” may be utilized instead of “SyncMaster.” With reference to cluster computing system 100, in one or more embodiments, configuration of the cluster and the frame-locking may be a sequential process, as all display units 108_{1-N} may be frame-locked either to a display timing of an internal SyncMaster device (e.g., a data processing device 102_{1-N}) or an external SyncMaster device. FIG. 3 shows an external SyncMaster device 350 (e.g., also communicatively coupled to server 170 through computer network 180 or by other means; external SyncMaster device 350 is external to data processing devices 102_{1-N}) also capable of being utilized for frame locking. In one or more embodiments, user 150 at server 170 may remotely query hardware capabilities of a first data processing device 102_{1-N} of cluster computing system 100.

In one or more embodiments, based on the remote query, data (e.g., hardware data 362) pertinent to the hardware capabilities of the first data processing device 102_{1-N} may be acquired and stored in memory 174. In one or more embodiments, user 150 at server 170 may then trigger a remote command to create a SyncMaster device. In one or more embodiments, the SyncMaster device may be the first data processing device 102_{1-N}, another data processing device 102_{1-N} of cluster computing system 100 or external SyncMaster device 350. In one or more embodiments, following the creation of the SyncMaster device, user 150 (e.g., through application 114) may configure the display topology of display unit 108_{1-N}, set a common timing thereto and frame-lock display unit 108_{1-N} to the SyncMaster device based on hardware data 362, hardware data associated with the another data processing device 102_{1-N} or hardware data associated with external SyncMaster device 350. FIG. 3 shows user interface 200 providing a capability to configure display topology 382, set a common timing 384 and frame-lock 386 display unit 108_{1-N} to the SyncMaster device. It is obvious that TC 302_{1-N} and SRC 304_{1-N} associated with the first data processing device 102_{1-N} may utilize the appropriate information (e.g., the common timing).

In one or more embodiments, the abovementioned processes may be enabled/triggered through a driver component 390 (e.g., a set of instructions) associated with processor 172, application 114 and/or operating system 128; for example, driver component 390 may be provided packaged with application 114 and/or operating system 128. FIG. 3 shows driver component 390 as being stored in memory 174. In one or more embodiments, in order to enable the abovementioned processes at data processing devices 102_{1-N}, the each data processing device 102_{1-N} may execute an instance of driver component 390 (e.g., driver component 390_{1-N}) thereon. FIG. 3 also shows driver component 390_{1-N} being stored in memory 106_{1-N}. In one or more embodiments, depending on the implementation, an acknowledgement may be transmitted to user 150 at server 170 following completion of the processes through driver component 390_{1-N} executing on the first data processing device 102_{1-N}.

In one or more embodiments, following successful receipt of the acknowledgement, server 170 may now remotely query hardware capabilities of the next data processing device 102_{1-N} coupled to the first data processing device 102_{1-N}. In one or more embodiments, based on the configuration of the first data processing device 102_{1-N} discussed above (FIG. 3 shows configuration data 364 following configuration of the first data processing device 102_{1-N} being available in memory 174), the display topology configuration, the common timing setting and the frame-locking of the corresponding display unit 108_{1-N} to the SyncMaster device may be performed through server 170. The aforementioned operations may be continued automatically until all data processing devices 102_{1-N} of cluster computing system 100 are configured and frame-locked. In one or more embodiments, errors during an operation may result in server 170 terminating the operations for the unconfigured data processing devices 102_{1-N}; server 170 may then generate a diagnostic log 366 (e.g., stored in memory 174) for user 150 to interpret.

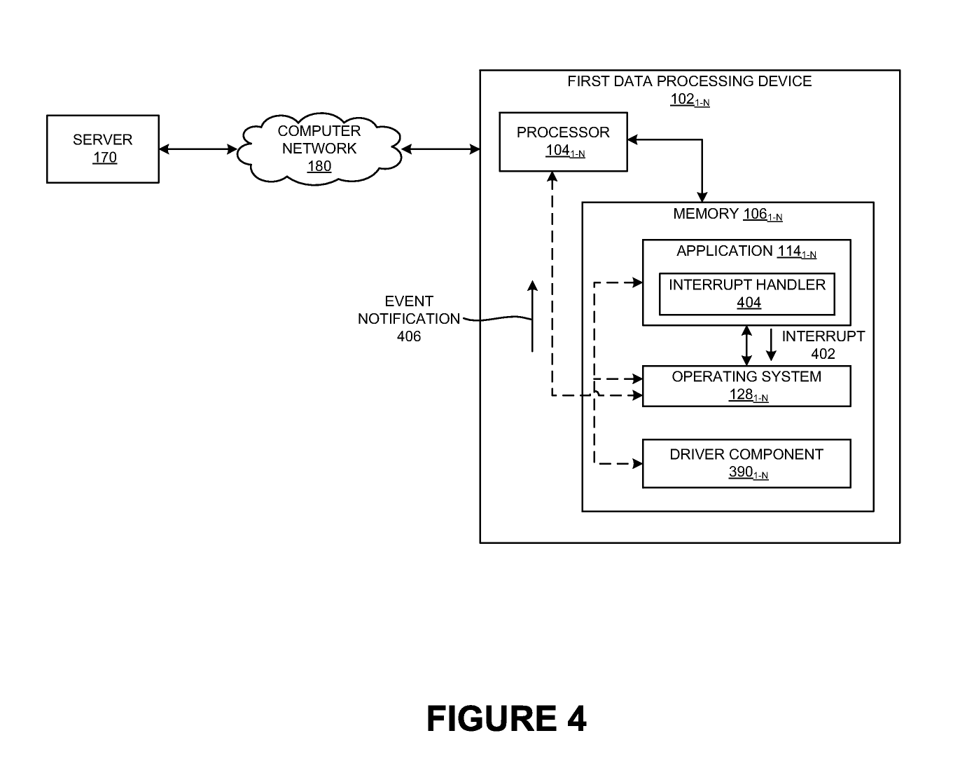

As discussed above, exemplary embodiments may not be limited to remote configuration of topologies of display units 108_{1-N} of cluster computing system 100 through server 170. Server 170 may also be employed to enable remote configuration of settings associated with screen 124, display unit 108_{1-N}, processor 104_{1-N}, memory 106_{1-N} and/or power supply 116_{1-N}. FIG. 4 illustrates data flow between the first data processing device 102_{1-N} and server 170 during the configuration of the settings discussed above, according to one or more embodiments. In one or more embodiments, the clicking of an appropriate button on user interface 200 by user 150 may generate an interrupt 402 to operating system 128_{1-N} on the first data processing device 102_{1-N}. In one or more embodiments, application 114_{1-N}, operating system 128_{1-N} and/or driver component 390_{1-N} may include an interrupt handler 404 to handle said interrupt 402. FIG. 4 shows interrupt handler 404 as being implemented in application 114_{1-N}. In one or more embodiments, following the handling of interrupt 402 through application 114_{1-N} and/or operating system 128_{1-N}, operating system 128 may generate an event notification 406 that is detected through processor 104_{1-N}. Thus, in one or more embodiments, processor 104_{1-N} may be apprised of the modification of the settings, which may then be effected in conjunction with application 114_{1-N} and/or operating system 128_{1-N}; the modification of the settings may also be effected solely through processor 104_{1-N}.

In one or more embodiments, driver component 390_{1-N} may then trigger the transmission of configuration data 364 to server 170 for utilization during configuration of settings associated with the next data processing device 102_{1-N}/display unit 108_{1-N} of cluster computing system 100. It should be noted that the first data processing device 102_{1-N} may be selected based on a optimal set of parameters that may also be optimal when utilized in other data processing devices 102_{1-N}/display units 108_{1-N}. Thus, in one or more embodiments, all data processing devices 102_{1-N} of cluster computing system 100 may be appropriately configured. All reasonable variations in implementation are within the scope of the exemplary embodiments discussed herein.

To summarize, exemplary embodiments provide for remote modification of settings associated with hardware components (including power supplies 116_{1-N}) of data processing devices 102_{1-N} and/or display units 108_{1-N} within cluster computing system 100. It should be noted that each data processing device 102_{1-N} may be associated with more than one display unit 108_{1-N}. FIG. 1 shows one display unit 108_{1-N} being associated with one data processing device 102_{1-N} of cluster computing system 100 merely for the sake of illustrative convenience. Also, remote configuration of settings associated with data processing devices 102_{1-N} and/or display units 108_{1-N} may also encompass other parameters such as aspect ratio, orientation, a number of displays (e.g., number of displays to be utilized as part of a display unit 108_{1-N}), display layout, color depth, color contrast, texture quality, buffering, frame rate, refresh rate, three-dimensional (3D) performance, edge enhancement, color enhancement, contrast enhancement, power save mode activation and/or optimization and transparency of windows (e.g., windows provided through operating system 128_{1-N} and/or application 114_{1-N}).

With respect to the remote configuration of display topologies discussed above, it should be noted that the device employed as the SyncMaster device may be dynamically modified to another device (e.g., another data processing device 102_{1-N}, external SyncMaster device 350) as and when server 170 deems it appropriate.

Last but not the least, in one or more embodiments, instructions associated with driver component 390/390_{1-N}, the configuration of settings associated with data processing devices 102_{1-N} and/or display unit 108_{1-N}, and/or application 114/application 114_{1-N} may be embodied on a non-transitory medium (e.g., a Compact Disc (CD), a Digital Video Disc (DVD), a Blu-ray Disc®, a hard drive) readable through data processing devices 102_{1-N} and/or server 170 to be executed therethrough.

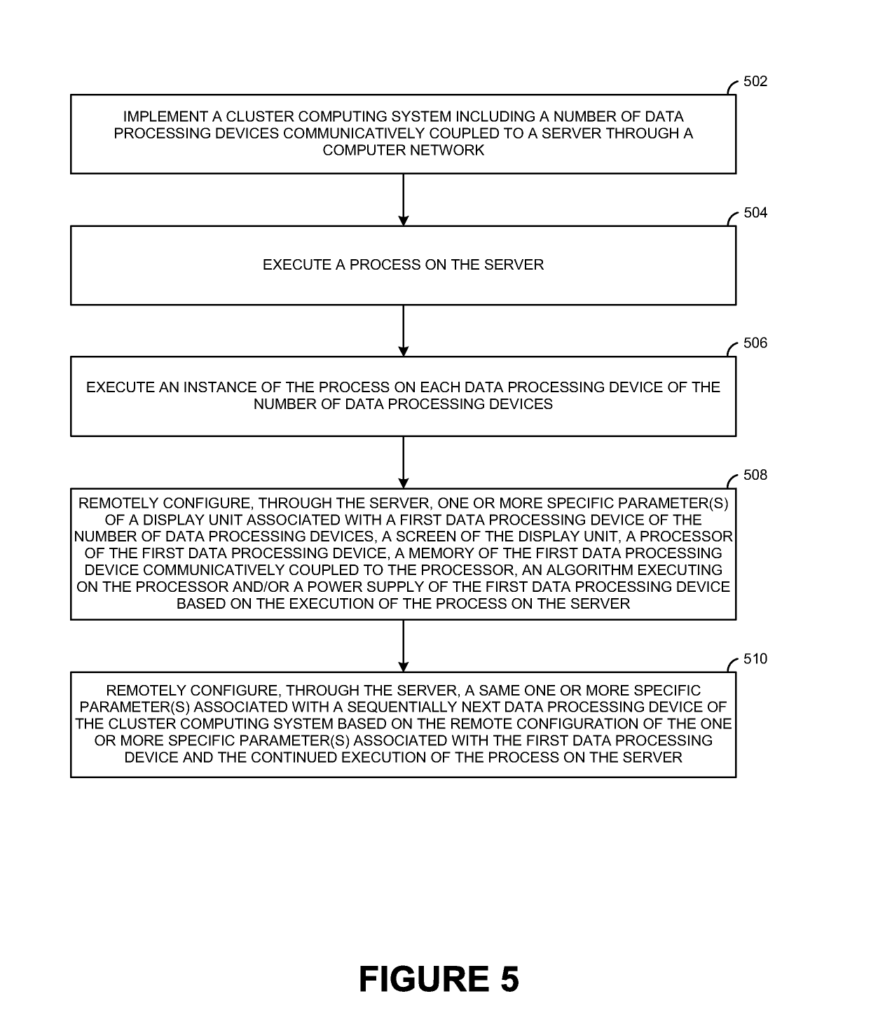

FIG. 5 shows a process flow diagram detailing the operations involved in remote configuration of data processing devices 102_{1-N} in cluster computing system 100, according to one or more embodiments. In one or more embodiments, operation 502 may involve implementing cluster computing system 100 including a number of data processing devices 102_{1-N} communicatively coupled to server 170 through computer network 180. In one or more embodiments, the number of data processing devices 102_{1-N} may include data processing devices 102_{1-N} coupled to one another in a daisy-chain configuration. In one or more embodiments, each data processing device 102_{1-N} of the number of data processing devices 102_{1-N} may be at a location remote from that of server 170.

In one or more embodiments, operation 504 may involve executing a process on server 170. In one or more embodiments, operation 506 may involve executing an instance of the process on the each data processing device 102_{1-N} of the number of data processing devices 102_{1-N}. In one or more embodiments, operation 508 may involve remotely configuring, through server 170, one or more specific parameter(s) of a display unit 108_{1-N} associated with a first data processing device 102_{1-N}, screen 124, a processor 104_{1-N} of the first data processing device 102_{1-N}, a memory 106_{1-N} of the first data processing device 102_{1-N} communicatively coupled to processor 104_{1-N}, an algorithm executing on processor 104_{1-N} and/or a power supply 116_{1-N} of the first data processing device 102_{1-N} based on the execution of the process on server 170.

In one or more embodiments, operation 510 may then involve remotely configuring, through server 170, a same one or more specific parameter(s) associated with a sequentially next data processing device 102_{1-N} of cluster computing system 100 based on the remote configuration of the one or more specific parameter(s) associated with the first data processing device 102_{1-N} and the continued execution of the process on server 170.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., server 170, data processing devices 102_{1-N}). Accordingly, the specification and drawings are to be regarded in an illustrative rather than a restrictive sense.

What is claimed is:

1. A method comprising:
implementing a cluster computing system comprising a plurality of data processing devices communicatively coupled to a server through a computer network, the plurality of data processing devices comprising data processing devices coupled to one another in a daisy-chain configuration, and each data processing device of the plurality of data processing devices being at a location remote from that of the server;
executing a process on the server;
executing an instance of the process on the each data processing device of the plurality of data processing devices;
remotely configuring, through the server, at least one specific parameter of at least one of: a display unit associated with a first data processing device of the plurality of data processing devices, a screen of the display unit, a processor of the first data processing device, a memory of the first data processing device communicatively coupled to the processor, an algorithm executing on the processor and a power supply of the first data processing device based on the execution of the process on the server; and
remotely configuring, through the server, a same at least one specific parameter associated with a sequentially next data processing device of the cluster computing system based on the remote configuration of the at least one specific parameter associated with the first data processing device and the continued execution of the process on the server.

2. The method of claim 1, further comprising:
remotely querying, through the server, a hardware capability of the first data processing device;
creating, through the server, a synchronization reference device out of one of: the first data processing device, another data processing device of the cluster computing system and a data processing device external to the plurality of data processing devices; and
through the server, remotely at least one of: configuring a topology of the display unit associated with the first data processing device, matching a display timing associated with the display unit with a timing associated with the synchronization reference device and frame-locking the display unit to the synchronization reference device.

3. The method of claim 2, further comprising dynamically modifying, through the server, the synchronization reference device to a second data processing device of the cluster computing system.

4. The method of claim 1, further comprising:
executing a driver component on the server to enable the remote configuration; and
executing an instance of the driver component on the each data processing device of the cluster computing system to convenience communication associated with the remote configuration.

5. The method of claim 1, comprising executing an application on the server as the process.

6. The method of claim 2, further comprising remotely querying, through the server, a hardware capability of the sequentially next data processing device following the at least one of: the configuration of the topology of the display unit, the display timing matching and the frame-locking to further perform at least one of: a configuration of a topology of a display unit associated with the sequentially next data processing device, a display timing matching associated therewith and frame-locking of the display unit associated with the sequentially next data processing device to the synchronization reference device.

7. The method of claim 5, comprising providing the driver component packaged with at least one of: the application and an operating system executing on the server.

8. A non-transitory medium, readable through a server and a plurality of data processing devices communicatively coupled to the server through a computer network to form a cluster computing system and including instructions embodied therein that are executable through the server and the plurality of data processing devices, the plurality of data processing devices comprising data processing devices coupled to one another in a daisy-chain configuration, and each data processing device of the plurality of data processing devices being at a location remote from that of the server, the non-transitory medium comprising:
instructions to execute a process on the server;
instructions to execute an instance of the process on the each data processing device of the plurality of data processing devices;
instructions to remotely configure, through the server, at least one specific parameter of at least one of: a display unit associated with a first data processing device of the plurality of data processing devices, a screen of the display unit, a processor of the first data processing device, a memory of the first data processing device communicatively coupled to the processor, an algorithm executing on the processor and a power supply of the first data processing device based on the execution of the process on the server; and
instructions to remotely configure, through the server, a same at least one specific parameter associated with a sequentially next data processing device of the cluster computing system based on the remote configuration of the at least one specific parameter associated with the first data processing device and the continued execution of the process on the server.

9. The non-transitory medium of claim 8, further comprising:
instructions to remotely query, through the server, a hardware capability of the first data processing device;
instructions to create, through the server, a synchronization reference device out of one of: the first data processing device, another data processing device of the cluster computing system and a data processing device external to the plurality of data processing devices; and
instructions to remotely, through the server, at least one of: configure a topology of the display unit associated with the first data processing device, match a display timing associated with the display unit with a timing associated with the synchronization reference device and frame-lock the display unit to the synchronization reference device.

10. The non-transitory medium of claim 9, further comprising instructions to dynamically modify, through the server, the synchronization reference device to a second data processing device of the cluster computing system.

11. The non-transitory medium of claim 8, further comprising:
instructions to execute a driver component on the server to enable the remote configuration; and
instructions to execute an instance of the driver component on the each data processing device of the cluster computing system to convenience communication associated with the remote configuration.

12. The non-transitory medium of claim 8, comprising instructions to execute an application on the server as the process.

13. The non-transitory medium of claim 9, further comprising instructions to remotely query, through the server, a hardware capability of the sequentially next data processing device following the at least one of: the configuration of the topology of the display unit, the display timing matching and the frame-locking to further perform at least one of: a configuration of a topology of a display unit associated with the sequentially next data processing device, a display timing matching associated therewith and frame-locking of the display unit associated with the sequentially next data processing device to the synchronization reference device.

14. A cluster computing system, comprising:
a server configured to execute a process thereon; and
a plurality of data processing devices communicatively coupled to the server through a computer network, the plurality of data processing devices comprising data processing devices coupled to one another in a daisy-chain configuration, each data processing device of the plurality of data processing devices being at a location remote from that of the server, and the each data processing device being configured to execute an instance of the process thereon,
wherein the server is configured to:
remotely configure at least one specific parameter of at least one of: a display unit associated with a first data processing device of the plurality of data processing devices, a screen of the display unit, a processor of the first data processing device, a memory of the first data processing device communicatively coupled to the processor, an algorithm executing on the processor and a power supply of the first data processing device based on the execution of the process, and
remotely configure a same at least one specific parameter associated with a sequentially next data processing device of the cluster computing system based on the remote configuration of the at least one specific parameter associated with the first data processing device and the continued execution of the process.

15. The cluster computing system of claim 14, wherein the server is configured to:
remotely query a hardware capability of the first data processing device,
create a synchronization reference device out of one of: the first data processing device, another data processing device of the cluster computing system and a data processing device external to the plurality of data processing devices, and
remotely at least one of: configure a topology of the display unit associated with the first data processing device, match a display timing associated with the display unit with a timing associated with the synchronization reference device and frame-lock the display unit to the synchronization reference device.

16. The cluster computing system of claim 15, wherein the server is further configured to dynamically modify the synchronization reference device to a second data processing device of the cluster computing system.

17. The cluster computing system of claim 14, wherein:
the server is further configured to execute a driver component thereon to enable the remote configuration, and
the each data processing device of the cluster computing system is configured to execute an instance of the driver component thereon to convenience communication associated with the remote configuration.

18. The cluster computing system of claim 14, wherein the server is configured to execute an application thereon as the process.

19. The cluster computing system of claim 15, wherein the server is further configured to remotely query a hardware capability of the sequentially next data processing device following the at least one of: the configuration of the topology of the display unit, the display timing matching and the frame-locking to further perform at least one of: a configuration of a topology of a display unit associated with the sequentially next data processing device, a display timing matching associated therewith and frame-locking of the display unit associated with the sequentially next data processing device to the synchronization reference device.

20. The cluster computing system of claim 18, wherein the driver component is provided packaged with at least one of: the application and an operating system executing on the server.
